(19) United States
(12) Patent Application Publication
(10) Pub. No.: US 2026/0316592 A1
(43) Pub. Date: Oct. 15, 2026

(54) CONTROL OF LOAD DISTRIBUTION IN DISTRIBUTED POWER SYSTEMS

(71) Applicant: GM GLOBAL TECHNOLOGY OPERATIONS LLC, DETROIT, MI (US)

(72) Inventor: Mohamed Ahmed Kamel Ahmed, Birmingham, MI (US)

(21) Appl. No.: 19/177,866

(22) Filed: Apr. 14, 2025

(51) Int. Cl. B60L 15/20; B60L 1/00; H02J 1/10; H02J 1/14

(52) U.S. Cl. CPC B60L 15/2045; H02J 1/106; H02J 1/14; B60L 1/00; B60L 2210/10

(57) ABSTRACT

A system includes a plurality of power modules connected in parallel to a common bus, and a controller configured to individually control each power module. The controller is configured to receive a desired load power, estimate a first power level for each power module based on an equal distribution of the desired load power, determine a peak system power, the peak system power equal to a sum of a peak power level of each power module, and compare the peak system power to the desired load power. The controller is also configured to, based on the desired load power being less than the peak system power, determine a subset of the plurality of power modules that are each operable at a respective optimum power level without exceeding the desired load power, and operate each of the subset at the respective optimum power level to supply energy to a load.

### INTRODUCTION

The subject disclosure relates to energy or power storage and transfer, and more particularly to distributed power systems, such as vehicle electrical systems having multiple parallel-connected power modules.

Vehicles, including gasoline and diesel powered vehicles, as well as electric and hybrid electric vehicles, feature battery storage for purposes such as powering electric motors, electronics and other vehicle subsystems. Battery systems provide power to various loads, including electric motors for propulsion, and accessories and components such as power control modules, heaters and cooling systems. Some vehicle electrical systems include distributed power systems, in which a plurality of power sources and/or conversion devices are connected in parallel.

### SUMMARY

In one exemplary embodiment, a system for controlling power transfer includes a plurality of power modules connected in parallel to a common bus, and a controller configured to individually control each power module of the plurality of power modules. The controller is configured to receive a desired load power for a load connected to the common bus, estimate a first power level for each power module of the plurality of power modules based on an equal distribution of the desired load power, determine a peak system power, the peak system power equal to a sum of a peak power level of each power module, and compare the peak system power to the desired load power. The controller is also configured to, based on the desired load power being less than the peak system power, determine a subset of the plurality of power modules that are each operable at a respective optimum power level without exceeding the desired load power, the optimum power level of a power module being a power level at which an efficiency is maximized, and operate each of the subset of the plurality of power modules at the respective optimum power level to supply electrical energy to the load.

In addition to one or more of the features described herein, the controller is configured to, based on the desired load power being greater than or equal to the peak system power, operate the plurality of power modules according to the equal distribution.

In addition to one or more of the features described herein, the controller is configured to, based on the desired load power being less than the peak power level, calculate a remaining amount of power, the remaining amount of power equal to a difference between a power output from the subset of the plurality of power modules and the desired load power.

In addition to one or more of the features described herein, the controller is configured to, based on the desired load power being less than the peak system power, operate each of the subset of the plurality of power modules at the respective optimum power level, and operate an additional power module at a selected power level corresponding to the remaining amount of power.

In addition to one or more of the features described herein, the controller is configured to, based on the desired load power being less than the peak system power, estimate a first amount of power loss associated with the equal distribution, and estimate a second amount of power loss associated with operating each of the subset of the plurality of power modules at the respective optimum power level and operating an additional power module at a selected power level corresponding to the remaining amount of power.

In addition to one or more of the features described herein, the controller is configured to operate each of the subset of the plurality of power modules at the respective optimum power level, and operate the additional power module, based on the first amount of power loss being greater than the second amount of power loss.

In addition to one or more of the features described herein, the controller is configured to operate the plurality of power modules according to the equal distribution, based on the first amount of power loss being less than or equal to the second amount of power loss.

In addition to one or more of the features described herein, the subset of the plurality of power modules is determined in real time as one or more of the plurality of power modules are successively activated, according to a power availability of each of the one or more power modules.

In addition to one or more of the features described herein, each power module of the plurality of power modules is selected from at least one of a battery and a conversion device.

In addition to one or more of the features described herein, each power module of the plurality of power modules is selected from one of a battery connected to a direct current (DC)-DC converter, a stage of a charging module, and a battery system connected to an inverter.

In another exemplary embodiment, a method of controlling power transfer includes receiving, by a controller, a desired load power to be supplied to a load from a power system including a plurality of power modules connected in parallel to a common bus, the controller configured to individually control each power module of the plurality of power modules. The method also includes estimating a first power level for each power module of the plurality of power modules based on an equal distribution of the desired load power, determining a peak system power, the peak system power equal to a sum of a peak power level of each power module of the plurality of power modules, and comparing the peak system power to the desired load power. The method further includes, based on the desired load power being less than the peak system power, determining a subset of the plurality of power modules that are each operable at a respective optimum power level without exceeding the desired load power, the optimum power level of a power module being a power level at which an efficiency is maximized, and operating each of the subset of the power modules at the respective optimum power level to supply electrical energy to the load.

In addition to one or more of the features described herein, the method further includes, based on the desired load power being greater than or equal to the peak system power, operating the plurality of power modules according to the equal distribution.

In addition to one or more of the features described herein, the method further includes, based on the desired load power being less than the peak system power, calculating a remaining amount of power, the remaining amount of power equal to a difference between a power output from the subset of the plurality of power modules and the desired load power.

In addition to one or more of the features described herein, the method further includes, based on the desired load power being less than the peak system power, operating each of the subset of the plurality of power modules at the respective optimum power level, and operating an additional power module at a selected power level corresponding to the remaining amount of power.

In addition to one or more of the features described herein, the method further includes, based on the desired load power being less than the peak system power, estimating a first amount of power loss associated with the equal distribution, estimating a second amount of power loss associated with operating each of the subset of the plurality of power modules at the respective optimum power level, and operating an additional power module at a selected power level corresponding to the remaining amount of power.

In addition to one or more of the features described herein, the method further includes operating each of the subset of the plurality of power modules at the optimum power level, and operating the additional power module, based on the first amount of power loss being greater than the second amount of power loss, and operating the plurality of power modules according to the equal distribution, based on the first amount of power loss being less than or equal to the second amount of power loss.

In addition to one or more of the features described herein, the subset of the plurality of power modules is determined in real time as one or more power modules are successively activated.

In yet another exemplary embodiment, a vehicle system includes a memory having computer readable instructions, and a processing device for executing the computer readable instructions, the computer readable instructions controlling the processing device to perform a method. The method includes receiving, by a controller, a desired load power to be supplied to a load from a power system including a plurality of power modules connected in parallel to a common bus, the controller configured to individually control each power module of the plurality of power modules. The method also includes estimating a first power level for each power module of the plurality of power modules based on an equal distribution of the desired load power, determining a peak system power, the peak system power equal to a sum of a peak power level of each power module of the plurality of power modules, and comparing the peak system power to the desired load power. The method further includes, based on the desired load power being less than the peak system power, determining a subset of the plurality of power modules that are each operable at a respective optimum power level without exceeding the desired load power, the respective optimum power level of a power module being a power level at which an efficiency is maximized, and operating each of the subset of the plurality of power modules at the respective optimum power level to supply electrical energy to the load.

In addition to one or more of the features described herein, the method further includes, based on the desired load power being greater than or equal to the peak system power, operating the plurality of power modules according to the equal distribution.

In addition to one or more of the features described herein, the method further includes, based on the desired load power being less than the peak system power, calculating a remaining amount of power, the remaining amount of power equal to a difference between a power output from the subset of the plurality of power modules and the desired load power.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a top view of a motor vehicle including a distributed power system, in accordance with an exemplary embodiment;

FIG. 2 depicts an example of a distributed power system;

FIG. 3 is a flow diagram depicting aspects of a method of controlling power transfer, in accordance with an exemplary embodiment;

FIG. 4 is a flow diagram depicting aspects of a method of controlling power transfer, in accordance with an exemplary embodiment;

FIG. 5 is a flow diagram depicting aspects of a method of controlling power transfer, in accordance with an exemplary embodiment;

FIG. 6 depicts an efficiency graph showing aspects of system efficiency based on the method of FIG. 3;

FIG. 7 depicts an efficiency graph showing aspects of system efficiency based on the method of FIG. 4;

FIG. 8 depicts an efficiency graph showing aspects of system efficiency based on the method of FIG. 5; and

FIG. 9 depicts a computer system in accordance with an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

In accordance with exemplary embodiments, methods, devices and systems are provided for controlling load distribution among power modules. The power modules are connected in parallel to a common bus and/or a common load. A “power module” refers to any parallel connected device or stage that provides power to a load (e.g., a conversion device, a charging module stage, parallel batteries connected to an inverter, etc.). In an embodiment, the power modules are part of an electrical system of a vehicle.

Methods are provided for controlling the power modules to improve system efficiency (e.g., as compared to equal power distribution among the power modules) or maximize system efficiency. An embodiment of a method includes receiving a desired load power, and evaluating each power module to determine an amount of power that is provided if each power module is operated at optimum efficiency. If the amount of power exceeds the desired load power, a subset of the power modules is selected to be operated at peak efficiency. A remaining amount of power is provided by operating an additional power module. In an embodiment, the method includes estimating an amount of loss associated with operating the power modules with equal distribution of power.

An embodiment of a method includes continuously or periodically monitoring system efficiency as each power module is activated. As each power module is activated, the current system power loss is estimated, and a number of power modules is determined that minimizes the system power loss. The determined power modules are operated at optimum efficiency.

The systems and methods described herein ensure that the load distribution among parallel-connected power modules results in a higher power conversion efficiency compared to equal load distribution among the power modules. The methods can be implemented on an embedded control for real-time processing or used to determine pre-calculated thresholds stored in, for example, a look-up table.

Embodiments described herein present numerous advantages and technical effects. For example, in a parallel-connected converter system, a load is equally shared among the parallel stages (conversion devices and associated power sources). Such equal load sharing may result in lower overall system efficiency. Embodiments address this limitation by providing systematic methods to distribute the load across the paralleled stages to achieve an improved or optimum efficiency.

The embodiments are not limited to use with any specific vehicle and may be applicable to various contexts. For example, embodiments may be used with automobiles, microgrid power systems, trucks, aircraft, construction equipment, farm equipment, automated factory equipment and/or any other device or system for which additional thermal control may be desired to facilitate a device or system's existing thermal control capabilities or features.

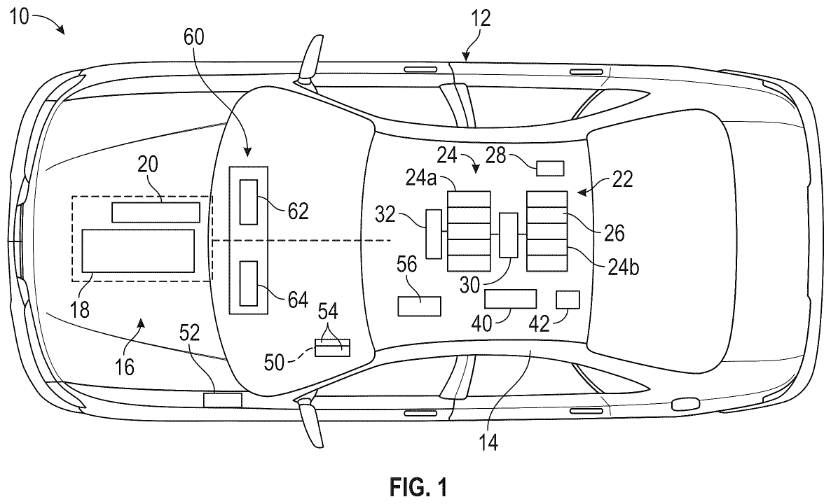

FIG. 1 shows an embodiment of a motor vehicle 10, which includes a vehicle body 12 defining, at least in part, an occupant compartment 14. The vehicle body 12 also supports various vehicle subsystems including a propulsion system 16, and other subsystems to support functions of the propulsion system 16 and other vehicle components, such as a braking subsystem, a suspension system, a steering subsystem, and if the vehicle is a hybrid electric vehicle, a fuel injection subsystem, an exhaust subsystem and others.

The vehicle 10 may be a combustion engine vehicle, an electrically powered vehicle (EV) or a hybrid vehicle. In an embodiment, the vehicle 10 is a hybrid vehicle that includes a combustion engine system 18 and at least one electric motor assembly. In an embodiment, the propulsion system 16 includes an electric motor 20, and may include one or more additional motors positioned at various locations. The vehicle 10 may be a fully electric vehicle having one or more electric motors.

The vehicle 10 includes a battery system 22, which may be electrically connected to the motor 20 and/or other components, such as vehicle electronics. The battery system 22 may be configured as a rechargeable energy storage system (RESS). In an embodiment, the battery system 22 includes a battery assembly such as a high voltage battery pack 24 having a plurality of battery modules 26. The battery system 22 may also include a monitoring unit 28 (e.g., battery management system or BMS controller) that includes components such as a processor, memory, an interface, a bus and/or other suitable components.

In an embodiment, the battery system 22 includes a plurality of distinct battery assemblies. For example, the HV battery pack 24 is separated into two separate battery packs 24a and 24b connected in parallel to a bus and to a direct current (DC)-DC converter 30. The battery system 22 is connected to the motor 20 via an inverter 32 (e.g., a traction power inverter module or TPIM) that converts DC power from the battery system 22 to poly-phase alternating current (AC) power (e.g., three-phase, six-phase, etc.) to drive the motor 20.

The battery system 22 may be a mixed chemistry battery system, in which the battery packs 24a and 24b have different chemistries. For example, one of the battery packs 24a and 24b includes cells having high energy density chemistries, such as Lithium-metal cells (e.g., LMB cells), Si-anode cells (lithium-ion cells having silicon-based anodes) and others. Another of the battery packs 24a and 24b may have a nickel manganese cobalt oxide (NCM) chemistry.

The vehicle 10 may include a low voltage distribution system 40 configured to supply power to one or more low voltage loads 42. “Low voltage” may refer to a voltage that is less than 110 V (e.g., 12V, 48V, etc.), or any other desired voltage level. Examples of low voltage loads 42 include electric motors, lights, infotainment equipment, electronic control units, climate control systems, including combinations and/or multiples thereof.

The low voltage distribution system 40 receives power from multiple parallel-connected power sources, which may be the battery packs 24a and 24b. The system 40 is not so limited, as there may be any type and number of sources (e.g., more than two battery packs, auxiliary battery, supplemental battery pack, etc.).

The vehicle 10 also includes a charging system, which can be used to charge the battery packs 24a and 24b, as well as any other battery or energy storage device in the vehicle 10. The charging system may also be configured to supply power to an external device or system. For example, the charging system enables vehicle-to-vehicle (V2V), vehicle-to-grid (V2G) and/or vehicle-to-everything (V2X) charging. The charging system includes one or more conversion devices for controlling aspects of charging and/or discharging. For example, at least one conversion device provides for conversion between AC current and DC current and/or voltage control. The conversion device may be a bi-directional conversion device that allows a charge port to be used for either charging or discharging.

In an embodiment, the charging system includes a charging control device 50, such as an onboard charging module (OBCM). The charging control device 50 includes a conversion device in the form of a charger (charge circuit) that includes devices for AC-DC conversion and DC-DC conversion. The charging control device 50 connects the battery system 22 to a charge port 52 for charging vehicle battery systems and/or providing charge to external storage systems.

The charging control device 50 may include multiple power modules or stages 54 connected in parallel to a single output. Each power module or stage 54 may include a respective power factor correction and rectification stage.

Various controllers or control modules may be included in the vehicle 10. For example, a vehicle controller 56 may be included to control aspects of vehicle 10 operation, such as driving the motor 20, controlling power supply to various components and controlling charging/discharging through the OBCM. In an embodiment, the vehicle controller 56 controls aspects of load distribution described herein.

The vehicle 10 also includes a computer system 60 that includes one or more processing devices 62 and a user interface 64. The various processing devices and units may communicate with one another via a communication device or system, such as a controller area network (CAN) or transmission control protocol (TCP) bus.

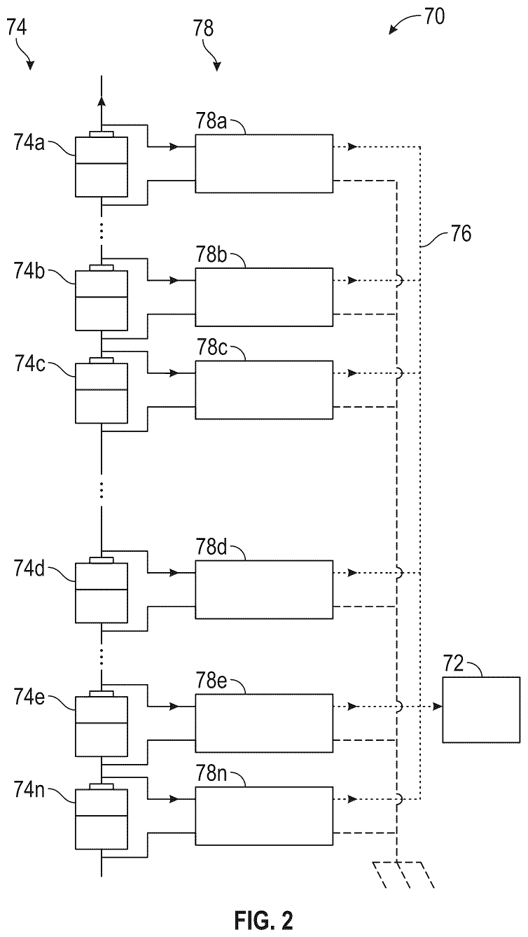

FIG. 2 is a schematic illustration of an example of a power distribution system 70 for providing power to a load 72. The system 70 includes a plurality of power sources 74 connected in parallel to a common bus 76. The bus 76 is further connected to an input of the load 72. Each power source 74 is connected to the bus 76 via a conversion device 78. For example, the conversion devices include DC-DC converters 78a-78n.

The power sources 74 may be batteries or battery assemblies. For example, each power source 74 is a battery assembly, denoted as batteries 74a-74n. The batteries each include any number of battery cells. For example, a battery may be a battery pack (e.g., the battery pack 24a or 24b), a group of cells, or a battery module (e.g., a module 26).

The DC-DC converters 78a-78n described herein can be controlled, such as by the vehicle controller 56 of FIG. 1, to manage aspects (e.g., current and/or voltage) of power provided by each DC-DC converter 78a-78n. The controller 56 or other processing device, in an embodiment, is a centralized controller that can individually instruct or command each DC-DC converter 78a-78n to output a specific power level.

A processing device, such as the vehicle controller 56, is configured to perform power management methods that include individually controlling conversion devices connected to parallel power sources. The conversion devices are controlled as described herein to maximize or optimize efficiency across various power levels.

Power losses affect efficiency in a variety of contexts. For example, power loss Pₗₒₛₛ in vehicle power systems from power converters includes conduction losses Pi, drive losses P_{drive}, auxiliary losses Pₐᵤₓ, and switching losses P_{sw}. A well-designed power conversion system is dominated by the conduction loss Pi.

Efficiency η can be evaluated for a single converter as follows:

$$η = \frac{{P}_{load}}{{P}_{load} + {P}_{loss}} ,$$

where the peak efficiency occurs at Pₒₚₜ.

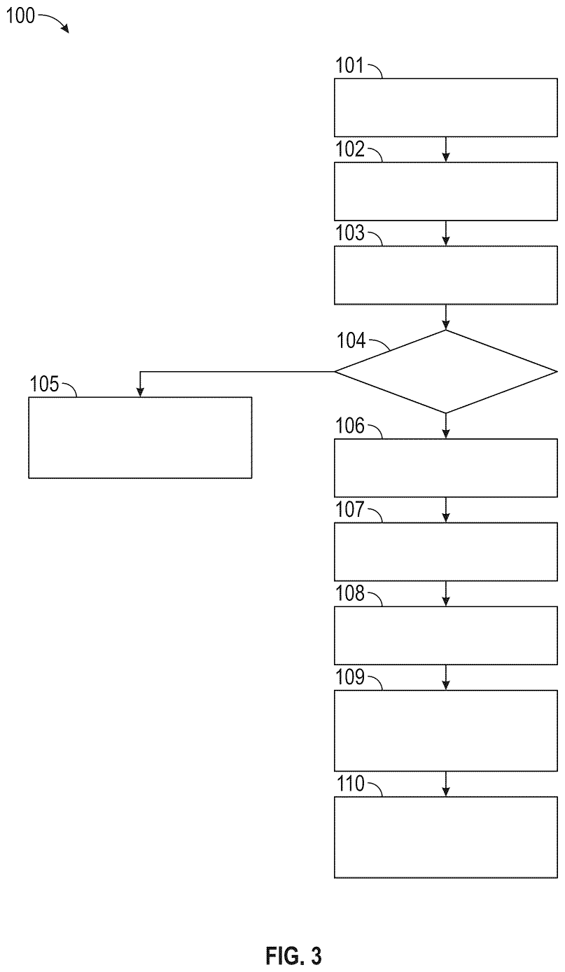

Embodiments of methods are discussed in conjunction with FIGS. 3-5. The methods are described in conjunction with a power system that includes multiple power modules connected in parallel to a common load. The power modules may be parallel connected conversion devices (e.g., DC-DC converters, AC-DC converters, transformers, etc.) or combinations thereof. However, it is to be understood that the methods can be applied to any suitable electric system that includes multiple devices or power stages connected in parallel to a common source and/or load.

For example, the methods can be applied to a motor-inverter system, such as the propulsion system 16 of FIG. 1. In this example, each power module is a battery module or set of battery cells connected in parallel to a motor (the common load). In this example, a set of switches in the inverter acts as a DC-DC converter for each set of battery cells.

In another example, the methods can be applied to a charging module having multiple parallel-connected stages. The common load in this example may be a battery system in a vehicle or an external system (e.g., another vehicle or a power grid).

Aspects of the methods may be performed by a processor or processors disposed in a vehicle, such as the vehicle controller 56. It is noted the methods are not so limited and may be performed by any suitable processing device or system, or combination of processing devices.

FIG. 3 depicts an embodiment of a method 100 of transferring power from parallel-connected power sources. The method 100 includes a number of steps or stages represented by blocks 101-110. The method 100 is not limited to the number or order of steps therein, as some steps represented by blocks 101-110 may be performed in a different order than that described below, or fewer than all of the steps may be performed.

At block 101, the processing device initiates a power system including a plurality of power modules (e.g., DC-DC converters 78a-78n) connected in parallel to a load. The power modules are enabled for base loads at this stage.

At block 102, the processing device calculates or determines a desired load power P_{load}. The desired load power may be determined by the processing device based on the type and requirements of a given load (e.g., lights, etc.).

At block 103, the processing device determines a number N of power modules to be used to provide power to the load. The number N is determined based on, for example, the number of available power modules.

The power modules are then evaluated based on an assumption of equal power distribution (i.e., each power module outputs the same power). The desired load power P_{load} is divided by the number N to calculate an amount of power P_{equal} that would be equally output by each of the N power modules.

At block 104, the processing device determines a power level Pₚₑₐₖ for each power module. Pₚₑₐₖ equals a maximum amount of power that can be provided by a specific power module. A peak system power level is calculated, which is the sum of the peak power Pₚₑₐₖ of each power module. In an embodiment, each power module has substantially the same peak power, and the peak system power is equal to N*Pₚₑₐₖ. The peak system power is then compared to the desired load power P_{load}.

At block 105, if the desired load power P_{load} is greater than or equal to the peak system power, the N power modules are activated to provide an equal amount of power to the load. Each power module is regulated such that P_{equal} is the target power for each power module. In other words, power is supplied with an equal power distribution among the power modules.

At block 106, if the desired load power P_{load} is less than the peak system power, a threshold number P_{threshold} is calculated, which is based on a number of power modules that can be operated at optimum power without exceeding the desired load power P_{load}. The threshold number may be calculated by dividing P_{load} by the optimum power of a set or group of power modules (P_{load}/Pₒₚₜ).

At block 107, the processor determines a subset of the power modules (i.e. a number F of power modules) that can be operated optimally without exceeding the desired load power P_{load}. The F power modules provide part of the desired load power provided at optimum power (F*Pₒₚₜ).

At block 108, a remaining amount of power Pᵣₑₘ is calculated as follows:

$${P}_{re m} = {P}_{threshold} - F * {P}_{opt} .$$

At block 109, the F power modules are activated and regulated based on each module's optimum power Pₒₚₜ. Each of the F power modules are operated with the optimum power Pₒₚₜ for each power module as a regulation target.

At block 110, an additional power module is activated and regulated with Pᵣₑₘ as a regulation target. In this way, all but one of the power modules is operated at optimum power, with the additional power module supplying power at a level below the additional power module's optimum power Pₒₚₜ.

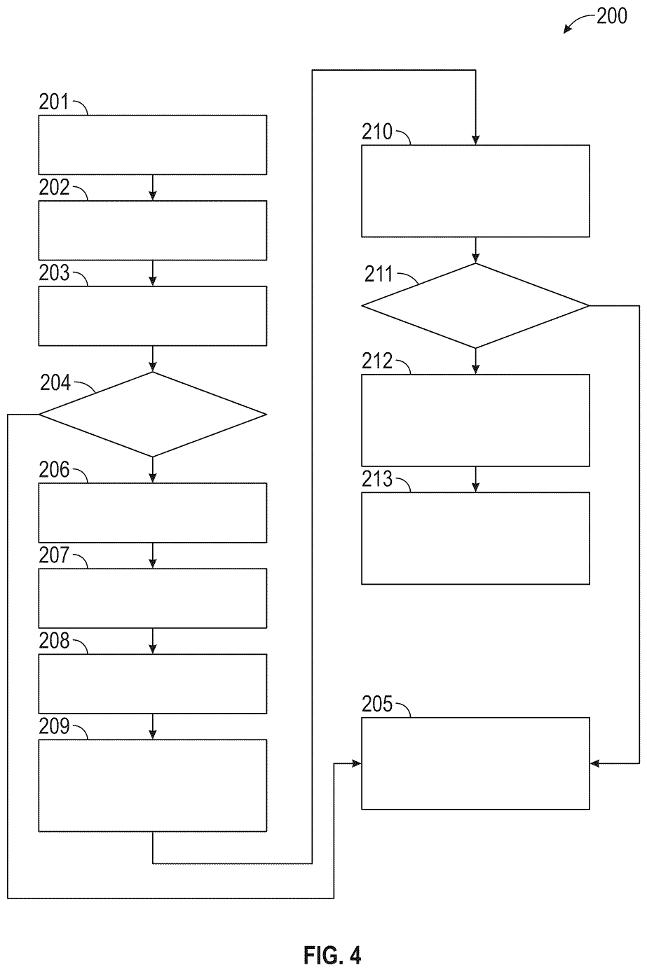

FIG. 4 depicts an embodiment of a method 200 of transferring power from parallel-connected power sources. The method 200 is similar to the method 100, with the addition of a determination of power loss.

The method 200 includes a number of steps or stages represented by blocks 201-213. The method 200 is not limited to the number or order of steps therein, as some steps represented by blocks 201-213 may be performed in a different order than that described below, or fewer than all of the steps may be performed.

At block 201, the processing device initiates a power system including a plurality of power modules (e.g., the DC-DC converters 78a-78n) connected in parallel to a load. At block 202, the processing device calculates or determines a desired load power P_{load}.

At block 203, the processing device determines a number N of power modules to be used to provide power to the load, and evaluates the power modules based on an assumption of equal power distribution. The desired load power P_{load} is divided by the number N to calculate (P_{equal}).

At block 204, the processing device determines a power level Pₚₑₐₖ for each power module. A peak system power level is calculated, which is the sum of the peak power Pₚₑₐₖ of each converter, and may be equal to N*Pₚₑₐₖ. The peak system power is then compared to the desired load power P_{load}.

At block 205, if the desired load power P_{load} is greater than or equal to the peak system power, the N power modules are activated to provide an equal amount of power to the load. Each power module is regulated such that P_{equal} is the target power for each power module.

At block 206, if the desired load power P_{load} is less than the peak system power, a threshold number P_{threshold} is calculated, which is based on a number of power modules that can be operated at optimum power without exceeding the desired load power P_{load}. The threshold number may be calculated by dividing P_{load} by the optimum power of a set of power modules (P_{load}/P opt).

At block 207, the processor determines a number F of power modules that can be operated optimally without exceeding the desired load power P_{load}. The F power modules provide part of the desired load power provided at optimum power (e.g., F*Pₒₚₜ).

At block 208, a remaining amount of power Pᵣₑₘ is calculated as follows:

$${P}_{re m} = {P}_{threshold} - F * {P}_{opt} .$$

At block 209, the processing device estimates an amount of loss (P_{loss,eq}) that would occur if power is equally distributed among the N power modules. At block 210, the processing device also estimates an amount of loss (P_{loss,m2}) that would occur if the power modules are operated such that each of the F power modules operate at optimum power Pₒₚₜ, and the additional power module is operated to provide the remaining power.

At block 211, Pₗₒₛₛ,eq is compared to P_{loss,m2}. If Pₗₒₛₛ,eq is less than or equal to P_{loss,m2}, the method 200 proceeds to block 205, and the N power modules are operated according to an equal distribution of power.

At block 212, if Pₗₒₛₛ,eq is greater than P_{loss,m2}, the F power modules are activated and regulated based on Pₒₚₜ.

At block 213, an additional power module is activated and regulated with Pᵣₑₘ as a regulation target.

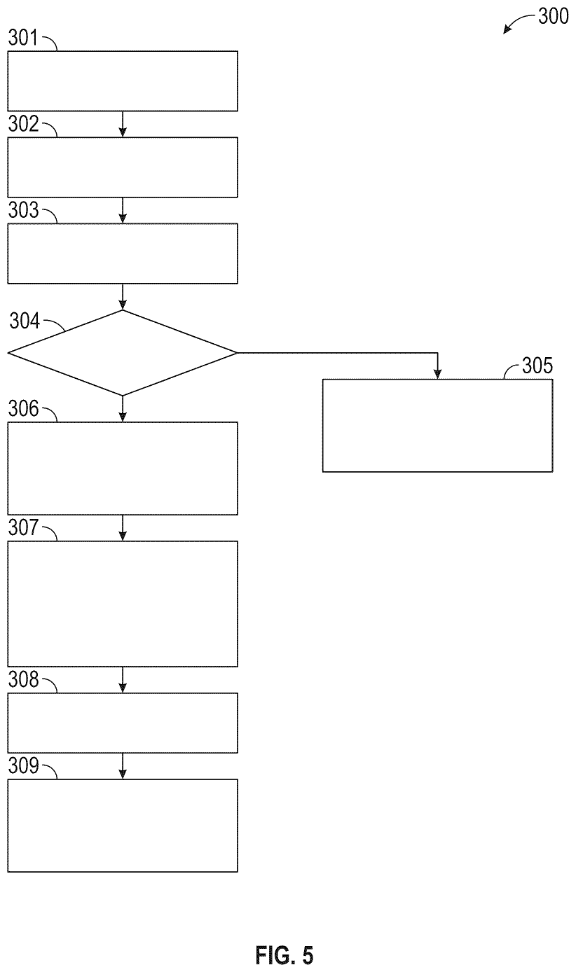

FIG. 5 depicts an embodiment of a method 300 of transferring power from parallel-connected power sources. The method 300 is performed in real time as each power module is successively activated, such that a loss determination is performed and the loss determination is used to determine when (or at what system power level) to activate a subsequent power module.

The method 300 includes a number of steps or stages represented by blocks 301-309. The method 300 is not limited to the number or order of steps therein, as some steps represented by blocks 301-309 may be performed in a different order than that described below, or fewer than all of the steps may be performed.

At block 301, the processing device initiates a power system including a plurality of power modules (e.g., the DC-DC converters 78a-78n) connected in parallel to a load. At block 302, the processing device calculates or determines a desired load power P_{load}. A minimum number x of power modules is assumed or determined, which may be one or more based on the configuration and requirements of the power system (e.g., a one or more power modules are active to power controllers).

At block 303, the processing device determines a number N of power modules to be used to provide power to the load, and evaluates the power modules based on an assumption of equal power distribution. The desired load power P_{load} is divided by the number N to calculate P_{equal}.

At block 304, the processing device determines a power level Pₚₑₐₖ for each power module. A peak system power level is calculated, which is the sum of the peak power Pₚₑₐₖ of each converter, and may be equal to N*Pₚₑₐₖ. The peak system power is then compared to the desired load power P_{load}.

At block 305, if the desired load power P_{load} is greater than or equal to the peak system power, the N power modules are activated to provide an equal amount of power to the load. Each power module is regulated such that P_{equal} is the target power for each power module.

If the desired load power is less than the peak system power, blocks 306-309 are performed iteratively as each power module is activated. In the following, k refers to the number of power modules that are currently being evaluated in a given iteration. k is an integer between one and N, and k is greater than or equal to x, where x is a minimum number (e.g., one) of power modules that need to be activated to run the system.

At block 306, for a given number k of power modules currently being evaluated, an amount of power P_{equalk} is calculated as P_{load}/k. P_{equalk} represents the power output of each of the k power modules under equal distribution.

At block 307, the processing device estimates an amount of loss (P_{loss,eq}) that would occur if power is equally distributed among the k power modules. The total power output from the k power modules is denoted as P_{load}, current, which may be less than the desired load power P_{load}. Blocks 306 and 307 may be repeated

At block 308, the processor determines a number K of power modules that minimize the power loss. For example, power loss in the system may be calculated at different levels of current, and the number K may be determined based on the power loss at known voltage and power.

At block 309, the number K of power modules are activated and regulated using P_{load}/K as a target.

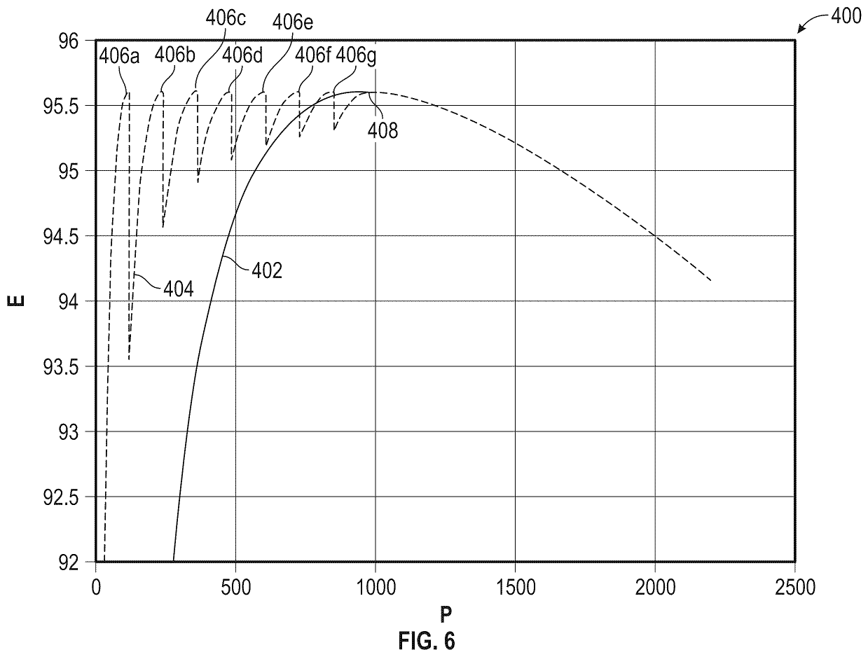

FIGS. 6-8 each include an efficiency graph 400, which illustrates examples of converter regulation using the methods described herein. In these examples, the graph 400 represents efficiency E (as a percentage) as a function of system power P (in Watts). The graph 400 includes a curve 402 that shows maximum efficiency of a power distribution system.

FIG. 6 includes a curve 404 that represents a power level of each power module determined according to the method 100, and shows system efficiency as each power module is activated to supply power to a load. Each peak in the curve 404 corresponds to activation of a respective power module. Peaks 406a-406g represent activation and operation of a subset of power modules (K power modules) at peak power. Peak 408 represents activation and operation of an additional power module to provide remaining power (Pᵣₑₘ).

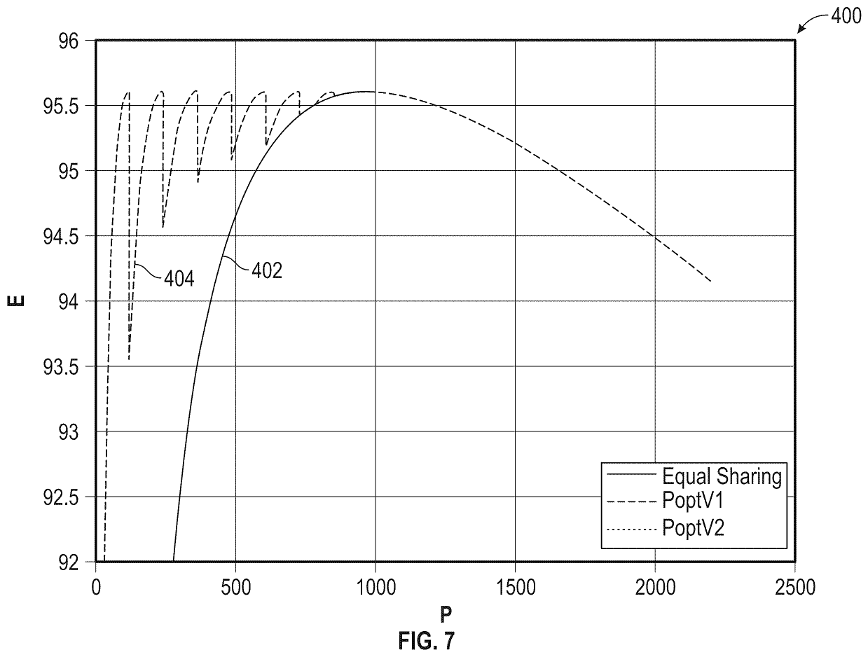

In FIG. 7, the curve 404 represents a power level of each power module determined according to the method 200, and shows system efficiency as each power module is activated to supply power to a load. As shown, the method 200 increases efficiency at higher loads by evaluating losses as described above.

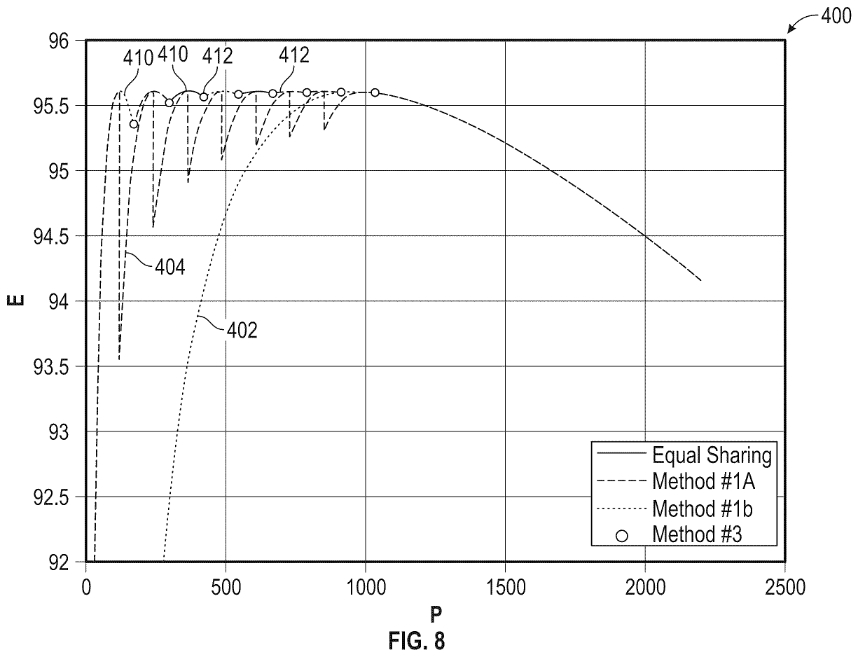

In FIG. 8, a curve 410 represents a power level and activation point of each power module determined according to the method 300, and shows system efficiency as each power module is activated to supply power to a load. Points 412 represent system voltage levels at which each power module is activated. As shown, by evaluating losses as each converter is activated, overall efficiency is improved by eliminating some of the efficiency loss that would otherwise occur as each power module is activated. For example, the drops in efficiency due to activation of the power modules is greatly reduced as compared to the curve 404.

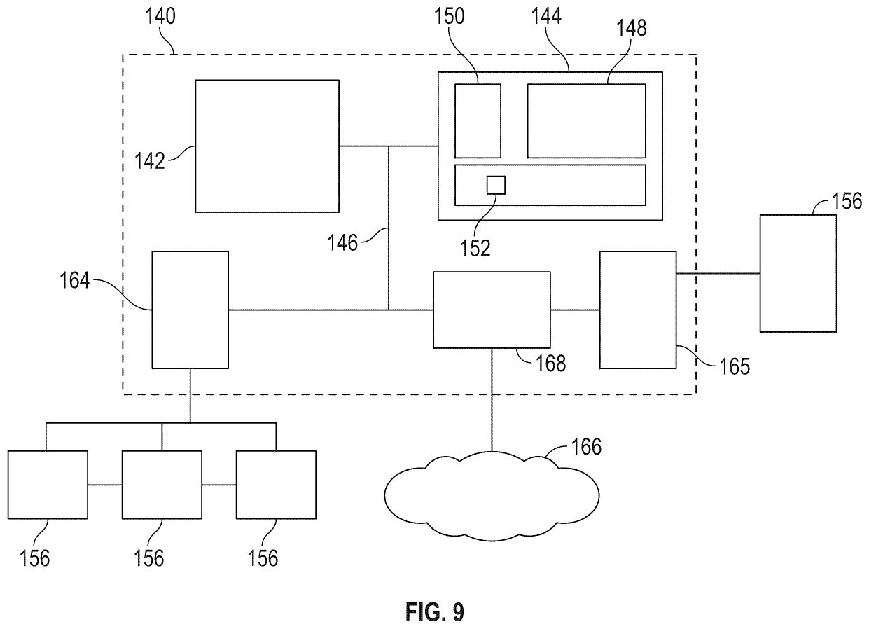

FIG. 9 illustrates aspects of an embodiment of a computer system 140 that can perform various aspects of embodiments described herein. The computer system 140 includes at least one processing device 142, which generally includes one or more processors for performing aspects of image acquisition and analysis methods described herein.

Components of the computer system 140 include the processing device 142 (such as one or more processors or processing units), a memory 144, and a bus 146 that couples various system components including the system memory 144 to the processing device 142. The system memory 144 can be a non-transitory computer-readable medium, and may include a variety of computer system readable media. Such media can be any available media that is accessible by the processing device 142, and includes both volatile and non-volatile media, and removable and non-removable media.

For example, the system memory 144 includes a non-volatile memory 148 such as a hard drive, and may also include a volatile memory 150, such as random access memory (RAM) and/or cache memory. The computer system 140 can further include other removable/non-removable, volatile/non-volatile computer system storage media.

The system memory 144 can include at least one program product having a set (e.g., at least one) of program modules that are configured to carry out functions of the embodiments described herein. For example, the system memory 144 stores various program modules that generally carry out the functions and/or methodologies of embodiments described herein. A module or modules 152 may be included to perform functions related to control of power transfer as discussed herein. The system 140 is not so limited, as other modules may be included. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 142 can also communicate with one or more external devices 156 as a keyboard, a pointing device, and/or any devices (e.g., network card, modem, etc.) that enable the processing device 142 to communicate with one or more other computing devices. Communication with various devices can occur via Input/Output (I/O) interfaces 164 and 165.

The processing device 142 may also communicate with one or more networks 166 such as a local area network (LAN), a general wide area network (WAN), a bus network and/or a public network (e.g., the Internet) via a network adapter 168. It should be understood that although not shown, other hardware and/or software components may be used in conjunction with the computer system 140. Examples include, but are not limited to: microcode, device drivers, redundant processing units, external disk drive arrays, RAID systems, and data archival storage systems, etc.

The terms “a” and “an” do not denote a limitation of quantity, but rather denote the presence of at least one of the referenced items. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made, and equivalents may be substituted for elements thereof without departing from its scope. In addition, many modifications may be made to adapt a particular situation or material to the teachings of the disclosure without departing from the essential scope thereof. Therefore, it is intended that the present disclosure is not limited to the particular embodiments disclosed, but will include all embodiments falling within the scope thereof.

What is claimed is:

1. A system for controlling power transfer, comprising:
a plurality of power modules connected in parallel to a common bus; and
a controller configured to individually control each power module of the plurality of power modules, the controller configured to:
receive a desired load power for a load connected to the common bus;
estimate a first power level for each power module of the plurality of power modules based on an equal distribution of the desired load power;
determine a peak system power, the peak system power equal to a sum of a peak power level of each power module;
compare the peak system power to the desired load power;
based on the desired load power being less than the peak system power, determine a subset of the plurality of power modules that are each operable at a respective optimum power level without exceeding the desired load power, the optimum power level of a power module being a power level at which an efficiency is maximized, and operate each of the subset of the plurality of power modules at the respective optimum power level to supply electrical energy to the load.

2. The system of claim 1, wherein the controller is configured to, based on the desired load power being greater than or equal to the peak system power, operate the plurality of power modules according to the equal distribution.

3. The system of claim 1, wherein the controller is configured to, based on the desired load power being less than the peak power level, calculate a remaining amount of power, the remaining amount of power equal to a difference between a power output from the subset of the plurality of power modules and the desired load power.

4. The system of claim 3, wherein the controller is configured to, based on the desired load power being less than the peak system power, operate each of the subset of the plurality of power modules at the respective optimum power level, and operate an additional power module at a selected power level corresponding to the remaining amount of power.

5. The system of claim 3, wherein the controller is configured to, based on the desired load power being less than the peak system power, estimate a first amount of power loss associated with the equal distribution, and estimate a second amount of power loss associated with operating each of the subset of the plurality of power modules at the respective optimum power level and operating an additional power module at a selected power level corresponding to the remaining amount of power.

6. The system of claim 5, wherein the controller is configured to operate each of the subset of the plurality of power modules at the respective optimum power level, and operate the additional power module, based on the first amount of power loss being greater than the second amount of power loss.

7. The system of claim 5, wherein the controller is configured to operate the plurality of power modules according to the equal distribution, based on the first amount of power loss being less than or equal to the second amount of power loss.

8. The system of claim 1, wherein the subset of the plurality of power modules is determined in real time as one or more of the plurality of power modules are successively activated, according to a power availability of each of the one or more power modules.

9. The system of claim 1, wherein each power module of the plurality of power modules is selected from at least one of a battery and a conversion device.

10. The system of claim 1, wherein each power module of the plurality of power modules is selected from one of a battery connected to a direct current (DC)-DC converter, a stage of a charging module, and a battery system connected to an inverter.

11. A method of controlling power transfer, comprising:
receiving, by a controller, a desired load power to be supplied to a load from a power system including a plurality of power modules connected in parallel to a common bus, the controller configured to individually control each power module of the plurality of power modules;
estimating a first power level for each power module of the plurality of power modules based on an equal distribution of the desired load power;
determining a peak system power, the peak system power equal to a sum of a peak power level of each power module of the plurality of power modules;
comparing the peak system power to the desired load power; and
based on the desired load power being less than the peak system power:
determining a subset of the plurality of power modules that are each operable at a respective optimum power level without exceeding the desired load power, the optimum power level of a power module being a power level at which an efficiency is maximized; and
operating each of the subset of the power modules at the respective optimum power level to supply electrical energy to the load.

12. The method of claim 11, further comprising, based on the desired load power being greater than or equal to the peak system power, operating the plurality of power modules according to the equal distribution.

13. The method of claim 11, further comprising, based on the desired load power being less than the peak system power, calculating a remaining amount of power, the remaining amount of power equal to a difference between a power output from the subset of the plurality of power modules and the desired load power.

14. The method of claim 13, further comprising, based on the desired load power being less than the peak system power, operating each of the subset of the plurality of power modules at the respective optimum power level, and operating an additional power module at a selected power level corresponding to the remaining amount of power.

15. The method of claim 13, further comprising, based on the desired load power being less than the peak system power, estimating a first amount of power loss associated with the equal distribution, estimating a second amount of power loss associated with operating each of the subset of the plurality of power modules at the respective optimum power level, and operating an additional power module at a selected power level corresponding to the remaining amount of power.

16. The method of claim 15, further comprising:
operating each of the subset of the plurality of power modules at the optimum power level, and operating the additional power module, based on the first amount of power loss being greater than the second amount of power loss; and
operating the plurality of power modules according to the equal distribution, based on the first amount of power loss being less than or equal to the second amount of power loss.

17. The system of claim 1, wherein the subset of the plurality of power modules is determined in real time as one or more power modules are successively activated.

18. A vehicle system comprising:
a memory having computer readable instructions; and
a processing device for executing the computer readable instructions, the computer readable instructions controlling the processing device to perform a method including:
receiving, by a controller, a desired load power to be supplied to a load from a power system including a plurality of power modules connected in parallel to a common bus, the controller configured to individually control each power module of the plurality of power modules;
estimating a first power level for each power module of the plurality of power modules based on an equal distribution of the desired load power;
determining a peak system power, the peak system power equal to a sum of a peak power level of each power module of the plurality of power modules;
comparing the peak system power to the desired load power; and
based on the desired load power being less than the peak system power:
determining a subset of the plurality of power modules that are each operable at a respective optimum power level without exceeding the desired load power, the respective optimum power level of a power module being a power level at which an efficiency is maximized; and
operating each of the subset of the plurality of power modules at the respective optimum power level to supply electrical energy to the load.

19. The vehicle system of claim 18, wherein the method further includes, based on the desired load power being greater than or equal to the peak system power, operating the plurality of power modules according to the equal distribution.

20. The vehicle system of claim 18, wherein the method further includes, based on the desired load power being less than the peak system power, calculating a remaining amount of power, the remaining amount of power equal to a difference between a power output from the subset of the plurality of power modules and the desired load power.
